(19) United States
(12) Patent Application Publication
(10) Pub. No.: US 2014/0171157 A1
(43) Pub. Date: Jun. 19, 2014

(54) PROTECTIVE SHELL AND CHARGING DEVICE COMBINATION FOR MOBILE PHONE

(71) Applicant: OXTI CORPORATION, Taipei (TW)

(72) Inventor: Chih Feng HO, Taipei (TW)

(73) Assignee: OXTI CORPORATION, Taipei (TW)

(21) Appl. No.: 13/714,689

(22) Filed: Dec. 14, 2012

(51) Int. Cl. H04M 1/02

(52) U.S. Cl. CPC H04M 1/026
USPC 455/573

(57) ABSTRACT

A protective shell and charging device combination includes a shell having a base member for attaching to an electrical facility, an attaching device attached to the base member of the shell, a charging device, and another attaching device attached to the charging device for engaging with the attaching device of the base member of the shell and for detachably attaching the charging device to the shell. The attaching devices include one or more magnetic attractive members for attracting or acting with each other and for detachably attaching the charging device to the shell. The shell includes a compartment formed by the base member, an upper member and a lower member for engaging with the mobile phone.

### BACKGROUND OF THE INVENTION

1. Field of the Invention

The present invention relates to a protective shell and charging device combination for portable or mobile phones, and more particularly to a protective sheath or shell and charging device combination including a protective sheath or shell for attaching or mounting or securing onto a portable or mobile phone for shielding and protecting the portable or mobile phone and including a portable charging device or facility for attaching or mounting or securing onto the portable or mobile phone with the protective sheath or shell and for easily and quickly and readily charging the portable or mobile phone or for providing an electric power to the portable or mobile phone.

2. Description of the Prior Art

Portable or mobile phones have been widely used today, and various kinds of typical charging devices or apparatuses or facilities have been developed and provided for charging the portable or mobile phones or for providing an electric power to the portable or mobile phones.

For example, U.S. Patent Application No. 2002/0147036 to Taguchi et al., and U.S. Patent Application No. 2007/0123315 to Williams J R. disclose two of the typical portable or mobile phones each comprising a typical charging device or apparatus or facility for electrically connecting or coupling to the portable or mobile phones or for providing an electric energy or power to the portable or mobile phones.

However, the typical charging devices or apparatuses or facilities are normally separated from the portable or mobile phones and received or carried in a pocket or purse or suitcase or the like, and may not be attached or mounted or secured or coupled or anchored to the portable or mobile phones such that the typical charging devices or apparatuses or facilities may not be carried with the users.

For example, when the previous batteries or power sources for the portable or mobile phones have been consumed, the users may have to open their pockets or purses or suitcases in order to search and find the required spare batteries or power sources or charging devices or apparatuses or facilities and then to electrically connect or couple the spare batteries or power sources or charging devices or apparatuses or facilities to the portable or mobile phones, and it thus takes time to search and find and couple the required spare batteries or power sources or charging devices or apparatuses or facilities to the portable or mobile phones.

Various kinds of typical protective shells or sheaths or shields or covers have also been developed and provided for attaching or mounting or securing onto the portable or mobile phone and for shielding and protecting the portable or mobile phone, however, the typical protective shells or sheaths or shields or covers may only be used for attaching or mounting or securing onto the portable or mobile phone, but may not be used for attaching or mounting or securing the other charging devices or apparatuses or facilities onto the portable or mobile phones.

The present invention has arisen to mitigate and/or obviate the afore-described disadvantages of the conventional portable or mobile phones and charging devices problems.

### SUMMARY OF THE INVENTION

The primary objective of the present invention is to provide a protective shell and charging device combination including a protective sheath or shell for attaching or mounting or securing onto a portable or mobile phone for shielding and protecting the portable or mobile phone and including a portable charging device or facility for attaching or mounting or securing onto the portable or mobile phone with the protective sheath or shell and for easily and quickly and readily charging the portable or mobile phone or for providing an electric power to the portable or mobile phone.

In accordance with one aspect of the invention, there is provided a protective shell and charging device combination for an electrical facility comprising a shell including a base member for attaching to the electrical facility, a first attaching device attached to the base member of the shell, a charging device, and a second attaching device attached to the charging device for engaging with the first attaching device and for detachably attaching the charging device to the shell.

The first attaching device includes at least one first magnetic attractive member engaged into the base member of the shell, and the second attaching device includes at least one second magnetic attractive member engaged into the charging device for attracting or acting with the first magnetic attractive member of the base member of the shell, and for detachably attaching the charging device to the shell.

The shell includes a compartment formed therein and defined by the base member, an upper member and a lower member and provided for clamping or engaging with the mobile phone. The shell includes two side members for forming and defining the compartment of the shell together with the upper member and the lower member.

The shell includes at least one first anchoring member, and the charging device includes at least one second anchoring member for engaging with the first anchoring member of the shell and for firmly or solidly or stably securing the charging device to the protective shell.

The first anchoring member of the shell is selected from a hole formed in the shell, and the second anchoring member of the charging device is selected from a catch extended outwardly from the charging device for selectively engaging with the hole of the shell.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a protective shell and charging device combination in accordance with the present invention for a portable or mobile phone;

FIG. 2 is another exploded view of the protective shell and charging device combination;

FIG. 3 is an exploded and cross sectional view of the protective shell and charging device combination;

FIG. 4 is a cross sectional view of the protective shell and charging device combination;

FIG. 5 is another cross sectional view of the protective shell and charging device combination similar to FIG. 4, in which the portable or mobile phone has been removed;

FIG. 6 is a further cross sectional view of the protective shell and charging device combination similar to FIGS. 4 and 5, in which the portable or mobile phone and the portable charging device or facility have been removed;

FIG. 7 is a plan schematic view illustrating the operation of the protective shell and charging device combination; and

FIG. 8 is another exploded and cross sectional view similar to FIG. 3, illustrating the other arrangement of the protective shell and charging device combination.

### DETAILED DESCRIPTION OF THE PREFERRED EMBODIMENT

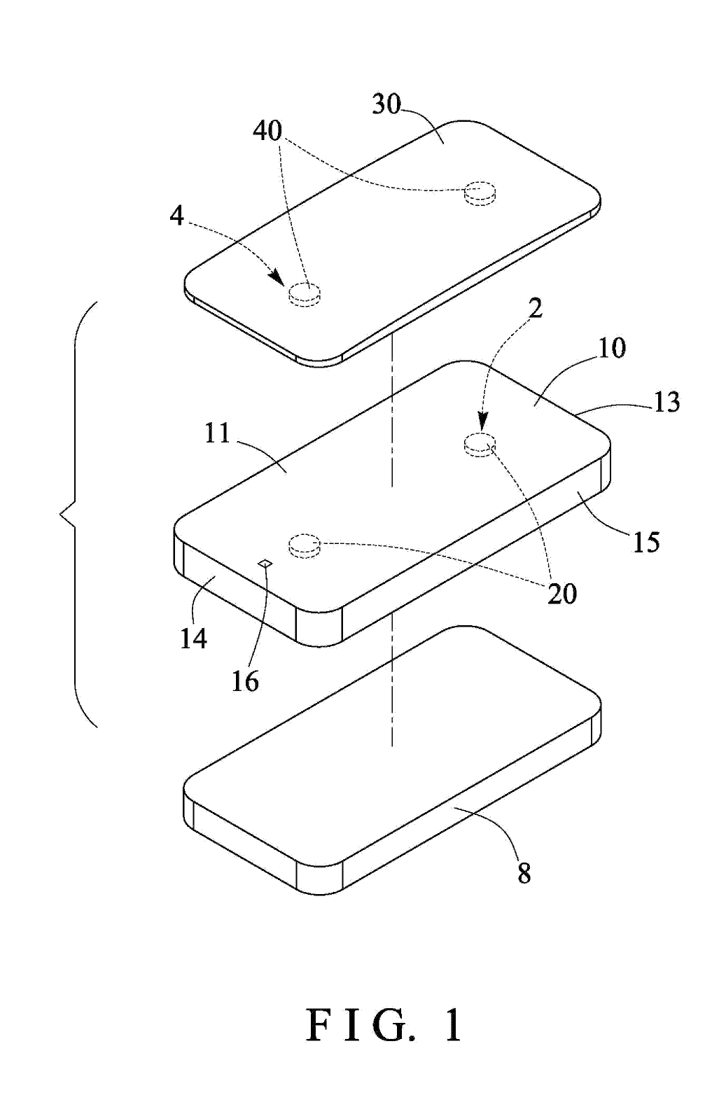

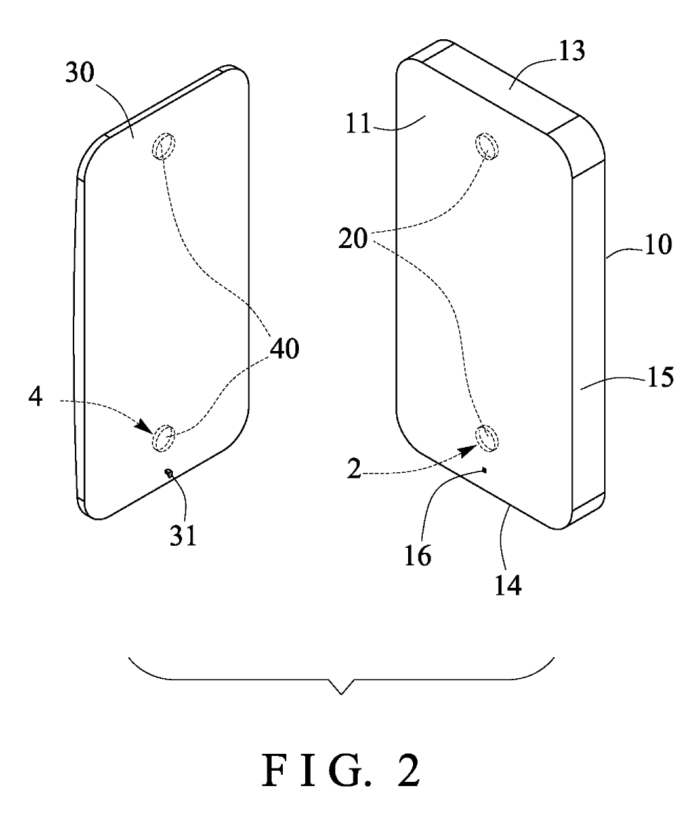

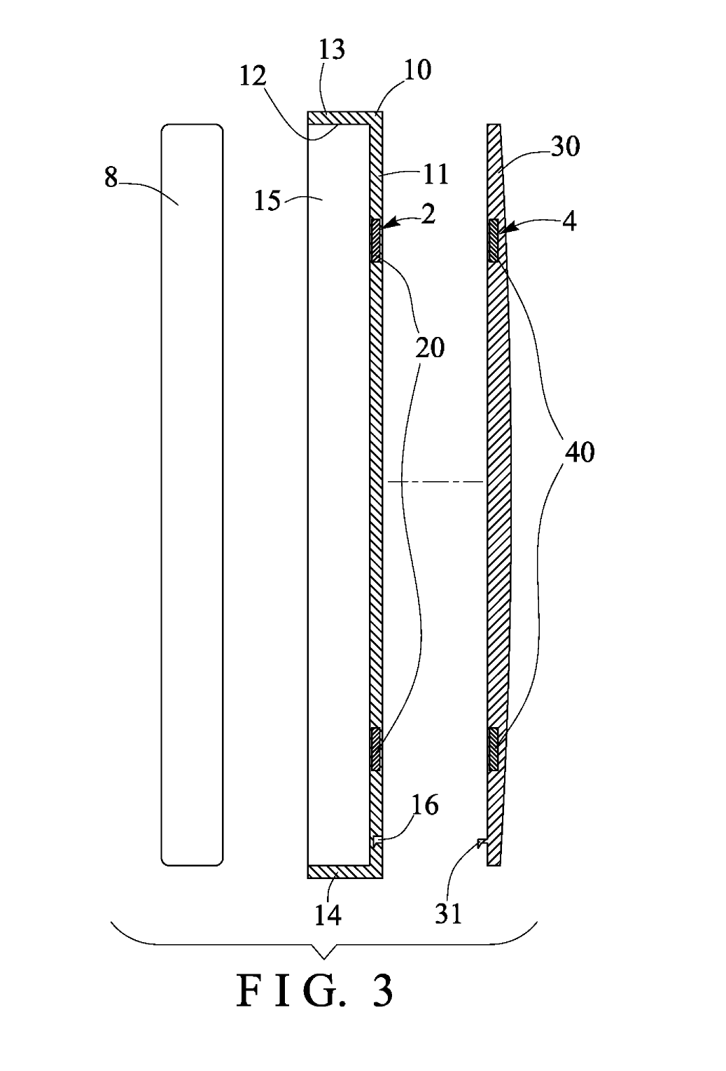

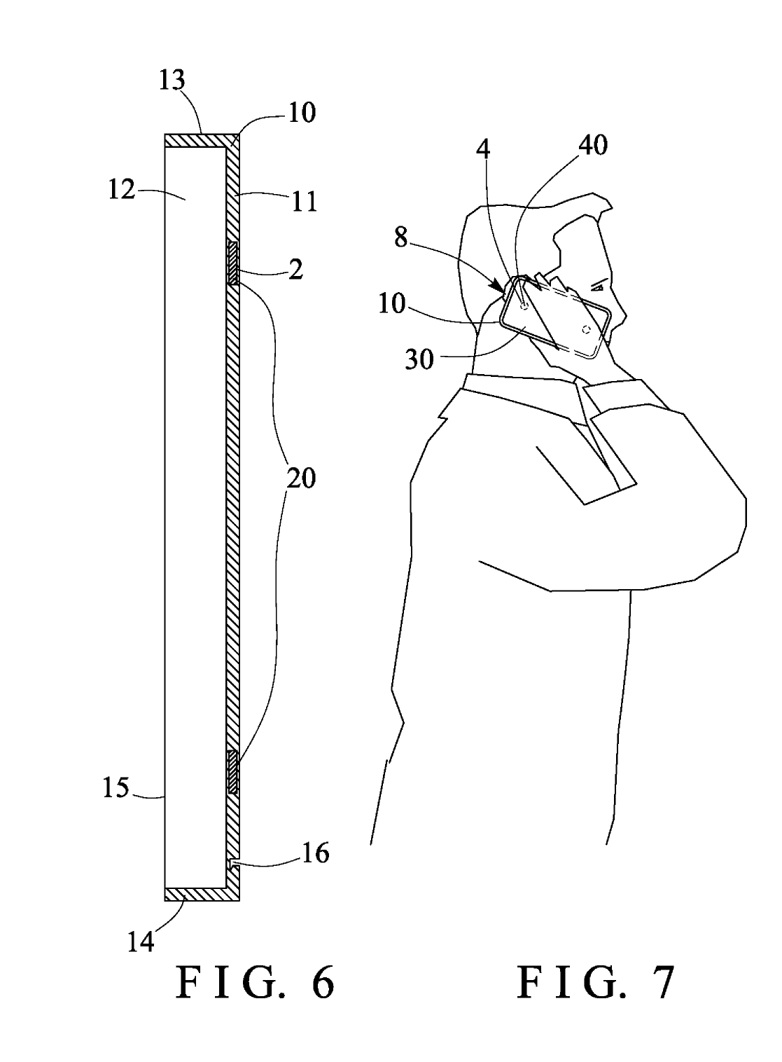

Referring to the drawings, and initially to FIGS. 1-6, a protective shell and charging device combination in accordance with the present invention comprises a protective sheath or shield or shell 10 including a bottom or base wall or panel or board or plate or member 11 for attaching or mounting or securing onto or engaging with an electrical apparatus or facility 8, such as a portable or mobile phone 8 (FIGS. 1, 3-4), and/or including a chamber or compartment 12 formed in the protective sheath or shield or shell 10 and formed or defined by the base wall or panel or board or plate or member 11, an upper plate or member 13, a lower or bottom plate or member 14, and/or two opposite side plates or members 15 for receiving or engaging with the portable or mobile phone 8.

The protective shell 10 further includes an attaching or mounting or securing or engaging or anchoring or retaining device 2 having one or more (such as two) magnets or magnetic attractive members 20 disposed or attached or mounted or secured or engaged into the protective shell 10, particularly, the base member 11 of the protective shell 10 for attracting or acting with the portable or mobile phone 8 and for detachably attaching or mounting or securing onto the mobile phone 8. The attaching device 2 may also be selected from the other mounting or securing or engaging or anchoring or retaining members or elements, such as the hook and loop fastening device for detachably attaching or mounting or securing the protective shell 10 onto the mobile phone 8.

It is to be noted that, without the attaching device 2, the protective shell 10 may also be attached or mounted or secured or disposed or engaged or anchored or retained or clamped onto the mobile phone 8 with the upper member 13 and the lower or bottom member 14, and/or the side members 15, for suitably shielding and protecting the mobile phone 8 and for preventing the mobile phone 8 from being scrubbed or scraped by the other objects or the like. The protective shell 10 may be made of soft or resilient materials selected from rubber, plastic, silicon, or composite materials or the like for easily and quickly and readily engaging onto the portable or mobile phone 8 and for softly or resiliently engaging with the portable or mobile phone 8.

The protective shell and charging device combination further includes a portable charging apparatus or facility or device 30 having another attaching or mounting or securing or engaging or anchoring or retaining device 4 which includes one or more (such as two) magnets or magnetic attractive members 40 disposed or attached or mounted or secured or engaged into the portable charging apparatus or facility or device 30 for attracting or acting with the magnets or magnetic attractive members 20 of the attaching device 2 of the protective shell 10 and for detachably attaching or mounting or securing the charging device 30 onto the protective shell 10. Similarly, the attaching device 4 may also be selected from the other mounting or securing or engaging or anchoring or retaining members or elements, such as the hook and loop fastening device for detachably attaching or mounting or securing the charging device 30 onto the protective shell 10 and thus for allowing the charging device 30 to be easily or suitably carried with the users.

The protective shell 10 may further includes one or more engaging or securing or retaining or lock or anchoring elements or members 16, such as notches or holes 16 formed therein, and the charging device 30 may further includes one or more engaging or securing or retaining or lock or anchoring elements or members 31, such as pegs or projections or protrusions or latches or catches 31 extended outwardly therefrom for selectively engaging with the anchoring members or holes 16 of the protective shell 10 and for firmly or solidly and stably anchoring or retaining or mounting or securing the charging device 30 to the protective shell 10, and for preventing the charging device 30 from being disengaged or separated from the protective shell 10. The structure or configuration and/or the function or operation of the charging device 30 is not related to the present invention and will not be described in further details.

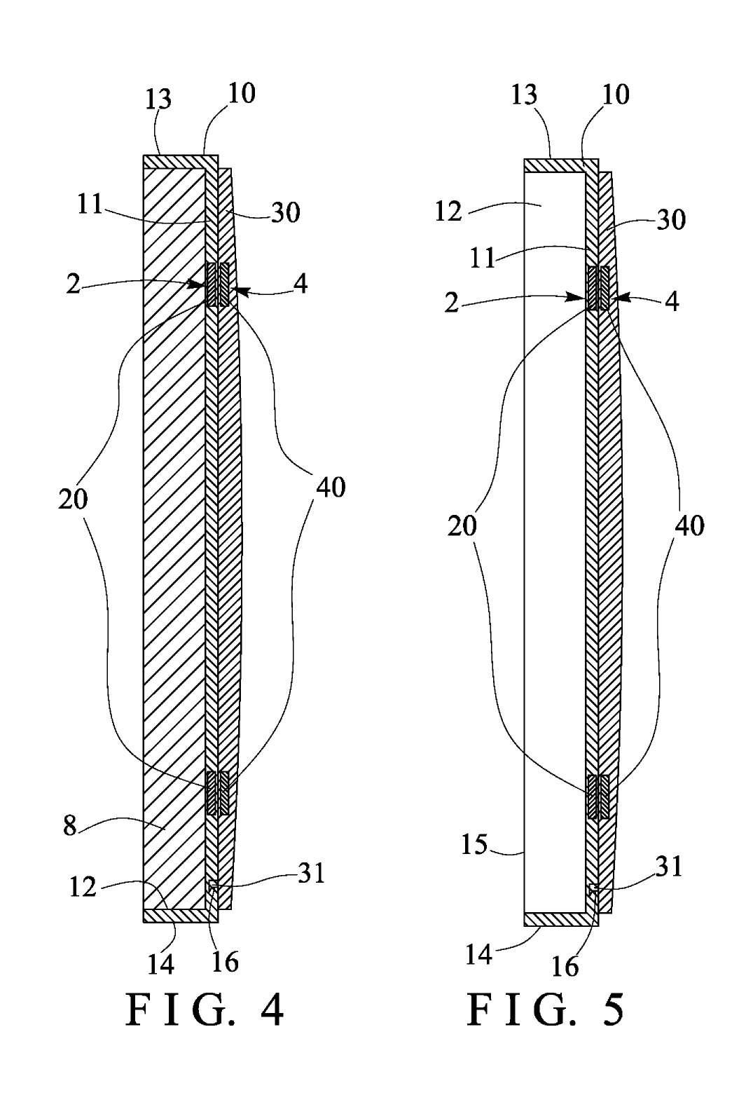

In operation, as shown in FIGS. 4 and 5, the protective shell 10 may be easily and quickly and readily attached or mounted or secured or anchored or retained to the mobile phone 8, and the charging device 30 may be easily and quickly and readily attached or mounted or secured or anchored or retained to the protective shell 10 with the magnetic attractive members 20, 40 of the attaching devices 2, 4 and/or the anchoring members or holes 16 of the protective shell 10 and the catches 31 that are extended outwardly from the charging device 30, and thus for allowing the charging device 30 to be easily or suitably used and carried with the users (FIG. 7). The magnetic attractive members 20, 40 of the attaching devices 2, 4 include different poles for attracting or acting with each other.

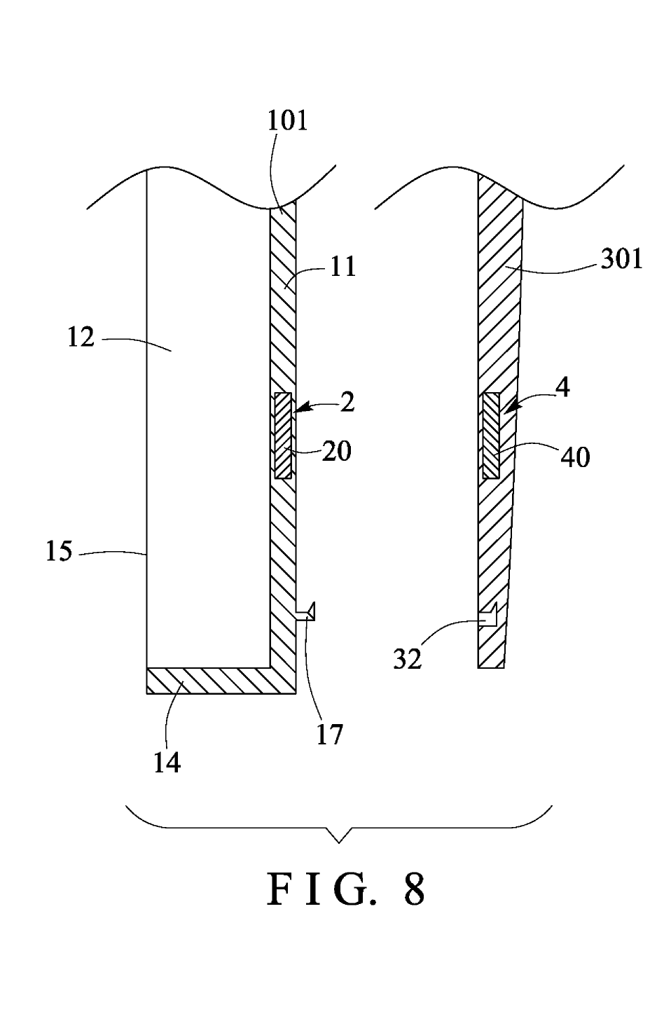

Alternatively, as shown in FIG. 8, the anchoring members 17 of the protective shell 101 may be selected from the anchoring members or pegs or projections or protrusions or latches or catches 17 extended outwardly from the protective shell 101, and the charging device 301 may be selected from the engaging or securing or retaining or lock or anchoring notches or holes 32 for selectively engaging with the anchoring members 17 of the protective shell 101 and thus for firmly or solidly and stably anchoring or retaining or mounting or securing the charging device 301 to the protective shell 101.

Accordingly, the protective shell and charging device combination in accordance with the present invention includes a protective sheath or shell for attaching or mounting or securing onto a portable or mobile phone for shielding and protecting the portable or mobile phone and including a portable charging device or facility for attaching or mounting or securing onto the portable or mobile phone with the protective sheath or shell and for easily and quickly and readily charging the portable or mobile phone or for providing an electric power to the portable or mobile phone.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A protective shell and charging device combination for an electrical facility comprising:
a shell including a base member for attaching to the electrical facility,
a first attaching device attached to said base member of said shell,
a charging device, and
a second attaching device attached to said charging device for engaging with said first attaching device and for detachably attaching said charging device to said shell.

2. The protective shell and charging device combination as claimed in claim 1, wherein said first attaching device includes at least one first magnetic attractive member engaged into said base member of said shell, and said second attaching device includes at least one second magnetic attractive member engaged into said charging device for acting with said at least one first magnetic attractive member of said base member of said shell, and for detachably attaching said charging device to said shell.

3. The protective shell and charging device combination as claimed in claim 1, wherein said shell includes a compartment formed therein and defined by said base member, an upper member and a lower member for engaging with the mobile phone.

4. The protective shell and charging device combination as claimed in claim 3, wherein said shell includes two side members for forming and defining said compartment of said shell together with said upper member and said lower member.

5. The protective shell and charging device combination as claimed in claim 1, wherein said shell includes at least one first anchoring member, and said charging device includes at least one second anchoring member for engaging with said at least one first anchoring member of said shell and for solidly securing said charging device to said protective shell.

6. The protective shell and charging device combination as claimed in claim 5, wherein said at least one first anchoring member of said shell is a hole formed in said shell, and said at least one second anchoring member of said charging device is a catch extended outwardly from said charging device for selectively engaging with said hole of said shell.
